(19) United States
(12) Patent Application Publication
(10) Pub. No.: US 2024/0328565 A1
(43) Pub. Date: Oct. 3, 2024

(54) VACUUM INSULATED APPARATUS WITH DARKLY COLORED CORE INSULATION MATERIAL AND METHOD OF MAKING THE SAME

(71) Applicant: WHIRLPOOL CORPORATION, BENTON HARBOR, MI (US)

(72) Inventor: Devidas B. Raskar, St. Joseph, MI (US)

(73) Assignee: WHIRLPOOL CORPORATION, BENTON HARBOR, MI (US)

(21) Appl. No.: 18/625,048

(22) Filed: Apr. 2, 2024

Related U.S. Application Data
(60) Provisional application No. 63/456,652, filed on Apr. 3, 2023.

(51) Int. Cl. F16L 59/065; C09D 5/00; C09D 7/40; C09D 7/41; C09D 7/62; C09D 7/65; F25D 23/06

(52) U.S. Cl. CPC F16L 59/065; C09D 5/00; C09D 7/41; C09D 7/62; C09D 7/65; C09D 7/70; F25D 23/06; F25D 2201/14

(57) ABSTRACT

A vacuum insulated apparatus including (a) an insulative structure with a sealed interior volume having a pressure of less than atmospheric pressure and (b) core insulation material disposed within the sealed interior volume, the core insulation material exhibiting a dark color and comprising (i) first particles and (ii) second particles or molecules coated onto or bonded to the first particles. The core insulation material exhibits CIELAB color space coordinates having an L* value within a range of from 0 to 40. The first particles can be fumed silica. The second particles or molecules can be dye particles or molecules. The first particles and the second particles or molecules can have opposite charges. The vacuum insulated structure can be a component of a refrigeration appliance, a dewar for liquid nitrogen, among other things.

### CROSS-REFERENCE TO RELATED APPLICATION

This application claims priority to and the benefit under 35 U.S.C. § 119 (e) of U.S. Provisional Application No. 63/456,652, filed on 3 Apr. 2023, entitled “DARKLY COLORED CORE INSULATION MATERIAL,” the disclosure of which is hereby incorporated herein by reference in its entirety.

### FIELD OF THE DISCLOSURE

This disclosure pertains to a vacuum insulated apparatus with darkly colored core insulation material, and more specifically, to modification of otherwise lightly colored core insulation material with particles or molecules to generate darkly colored core insulation material with improved radiative thermal conductivity.

### BACKGROUND

A vacuum insulated apparatus, such as a refrigerator appliance, sometimes includes an insulative structure containing both fumed silica and carbon black as core insulation material. The fumed silica is thought to decrease solid conductivity of heat through the insulative structure because particles of fumed silica are small and porous. The carbon black is thought to decrease radiative conductivity of thermal radiation through the insulative structure because carbon black has a dark color and a high extinction coefficient. However, there is a problem in that carbon black simultaneously increases solid conductivity (countering the low solid conductivity of fumed silica) because carbon black has a large particle size compared to fumed silica and is not porous.

### SUMMARY

The present disclosure addresses that problem with core insulation material that includes first particles, such as fumed silica that have low solid conductivity, and second particles or molecules coated upon or bonded to the first particles to impart the core insulation material with a black or dark color and thus a low radiative thermal conductivity.

According to one aspect of the present disclosure, a vacuum insulated apparatus includes (a) an insulative structure with a sealed interior volume having a pressure of less than atmospheric pressure; and (b) core insulation material disposed within the sealed interior volume, the core insulation material exhibiting a dark color and comprising (i) first particles and (ii) second particles or molecules coated onto or bonded to the first particles.

According to another aspect of the present disclosure, a method of manufacturing a vacuum insulated apparatus comprising: (a) a coating step comprising coating or bonding first particles with second particles or molecules to form core insulation material; (b) a depositing step comprising depositing the core insulation material into an interior volume of an insulative structure; and (c) a sealing step comprising reducing a pressure within the interior volume of the insulative structure within which the core insulation material is disposed and sealing the interior volume.

According to yet another aspect of the present disclosure, a refrigeration appliance comprises: (a) an insulative structure with a sealed interior volume having a pressure of less than atmospheric pressure; and (b) core insulation material disposed within the sealed interior volume, the core insulation material exhibiting a dark color and comprising first particles and second particles or molecules coated onto or bonded to the first particles, wherein (i) the core insulation material exhibits CIELAB color space coordinates that have an L* value within a range of from 0 to 40, (ii) the second particles or molecules are coated onto or bonded to the first particles or molecules via Van der Walls forces, hydrogen bonding, ionic bonding, or covalent bonding, (iii) the first particles are chosen from a group consisting of fumed silica, perlite, vermiculite, expanded polystyrene, polyurethane, and glass fiber, (iv) the first particles, without the second particles or molecules coated onto or bonded thereto, exhibit CIELAB color space coordinates that have an L* value that is greater than 40, and (v) the core insulation material exhibits a total thermal conductivity that is less than a total thermal conductivity that the first particles alone exhibit.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a schematic diagram of a vacuum insulated apparatus of the present disclosure, illustrating (i) an insulative structure with a sealed interior volume and core insulation material disposed therein and (ii) the core insulation material including first particles and second particles or molecules coated upon or bonded thereto;

FIG. 2 is an elevational view of the vacuum insulated apparatus of FIG. 1 in the form of a refrigeration appliance of the present disclosure;

FIG. 3 is a side perspective view of a cross-section of the refrigeration appliance of FIG. 2, taken through line III-III of FIG. 2, illustrating a cabinet (as the insulative structure) with the sealed interior volume within which core insulation material is disposed to provide insulation to the refrigeration appliance and limit thermal transfer between an external environment and one or more refrigeration compartments;

FIG. 4 is an enlarged view of area IV of FIG. 3, illustrating the core insulation material within the sealed interior volume of the cabinet formed by an outer wrapper and an inner liner of the cabinet;

FIG. 5 is an elevational view of a cross-section of a panel (as the insulative structure) that includes the core insulation material and could be incorporated into a refrigeration appliance to insulate a refrigeration compartment;

FIG. 6 is a schematic flow chart of a method of manufacturing the vacuum insulate apparatus of FIG. 1; and

FIG. 7 is a schematic diagram of first particles being subjected to a coating step where second particles or molecules are coated upon and/or bonded to the first particles to form the core insulation material of FIG. 1.

The components in the figures are not necessarily to scale, emphasis instead being placed upon illustrating the principles described herein.

### DETAILED DESCRIPTION

The present illustrated embodiments reside primarily in combinations of method steps and vacuum insulated apparatus components including core insulation material, which can take the form of household appliances such as a refrigeration appliance. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

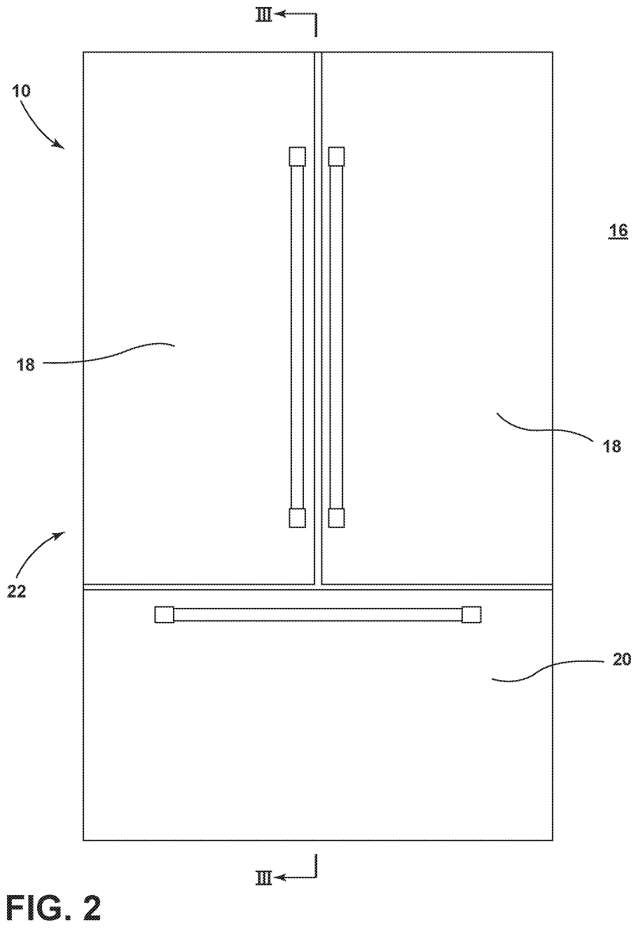

For purposes of description herein, the terms “upper,” “lower,” “right,” “left,” “rear,” “front,” “vertical,” “horizontal,” and derivatives thereof shall relate to the disclosure as oriented in FIG. 2. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

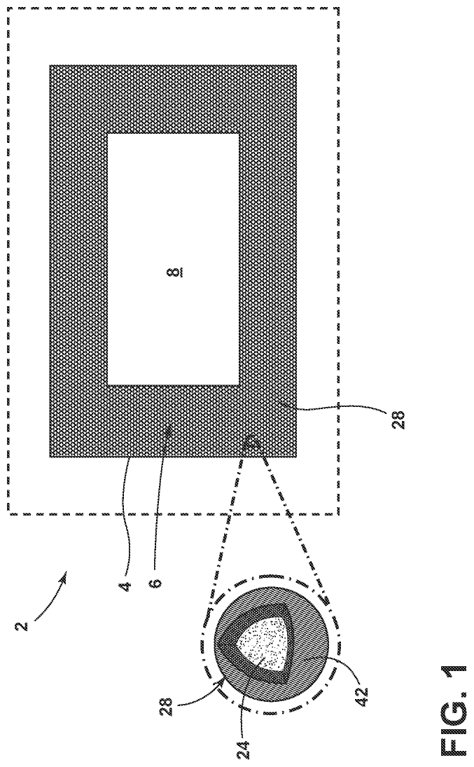

Referring to FIG. 1, a vacuum insulated apparatus 2 includes an insulative structure 4. The insulative structure 4 forms a sealed interior volume 6. The sealed interior volume 6 has a pressure of less than atmospheric pressure. The sealed interior volume 6 can at least partially surround or form a chamber 8. A substance (not illustrated) can be disposed within the chamber 8 to be maintained at a temperature different than ambient temperature.

The vacuum insulated apparatus further includes core insulation material 28. The core insulation material 28 is disposed within the sealed interior volume 6. The core insulation material 28 exhibits a dark color. For example, the dark color can be black or a gray color. In embodiments, the core insulation material 28 exhibits CIELAB color space coordinates that have an L* value of from 0 to 40. In embodiments, the core insulation material 28 exhibits an L* value that is 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40, or within any range bound by any two of those values (e.g., from 0 to 24, from 4 to 38, and so on). The L* value is sometime referred as the lightness value. An L* value of 0 is black while an L* value of 100 is diffuse white. In embodiments, the core insulation material 28 exhibits an a* value of the CIELAB color space coordinates that is within a range of from −20 to 20, and a b* value that is within a range of from −20 to 20. However, the closer the L* value is to 0, the more the a* and the b* values can exceed those ranges and the core insulation material 28 still exhibits a dark color, such as black or a gray.

The core insulation material 28 includes first particles 42 and second particles or molecules 44 that are coated onto or bonded to the first particles 42. For example, in embodiments, the second particles or molecules 44 are coated onto or bonded to the first particles 42 via Van der Walls forces, hydrogen bonding, ionic bonding, or covalent bonding. In the case of fumed silica, for example, the fumed silica has a negative surface charge, even in a dry state. Thus, the second particles or molecules 44 with a positive charge are attracted to the negative surface charge of the fumed silica and bond thereto. In some instances, surfaces of the first particles 42 can be modified to have a negative charge. The coating or bonding of the second particles or molecules 44 onto the first particles 42 imparts the core insulation material 28 with the color that the core insulation material 28 exhibits.

In some instances, the first particles 42 alone do not exhibit a black or a dark color, but with the second particles or molecules 44 coated thereupon or bonded thereto, the core insulation material 28 (as a composite of the first particles 42 and the second particles or molecules 44) does exhibit a black or dark color, due to the contribution of the second particles or molecules 44.

In embodiments, the first particles 42 include one or more of fumed silica, perlite, vermiculite, expanded polystyrene, and polyurethane. The first particles 42 of such compositions are effective insulators for refrigeration appliances, such as the refrigeration appliance 10. However, the first particles 42 of such compositions do not exhibit a dark color, such as black or a gray. Thus, the first particles 42 may provide little benefit to lowering radiative thermal conductivity. In embodiments, the first particles 42 alone, that is, without the second particles or molecules 44 coated onto or bonded thereto, exhibit CIELAB color space coordinates that have an L* value that is greater than 40. For example, the first particles 42 alone can exhibit an L* value that is greater than 40, 50, 60, 70, 80, 90, or 100, or within any range bound by any two of those values (e.g., from 50 to 100, from 60 to 90, and so on). In some instances, the first particles 42 alone exhibit a white or a light gray color.

In embodiments, the second particles or molecules 44 include one or more of organic dye molecules and inorganic dye molecules. Categories of organic dye molecules include azo dye molecules, anthraquinone dye molecules, phthalocyanine molecules, quinoline dye molecules, and sulfur dye molecules. Examples of azo dye molecules include molecules of one or more of Direct Black 38 (e.g., 4-amino-3-[[4-[4-[(2,4-diaminophenyl)diazenyl]phenyl]phenyl]diazenyl]-5-hydroxy-6-phenyldiazenylnaphthalene-2,7-disulfonic acid), Acid Black 210 (e.g., 5-amino-3-[[4-[[4-[(2,4-diaminophenyl)diazenyl]phenyl]sulfamoyl]phenyl]diazenyl]-4-hydroxy-6-[(4-nitrophenyl)diazenyl]naphthalene-2,7-disulfonate), Naphthol Blue Black (e.g., 4-amino-5-hydroxy-3-[(4-nitrophenyl)diazenyl]-6-phenyldiazenylnaphthalene-2,7-disulfonate), Reactive Black 5 (e.g., 4-amino-5-hydroxy-3,6-bis [[4-(2-sulfonatooxyethylsulfonyl)phenyl]diazenyl]naphthalene-2,7-disulfonate), and Disperse Black 9 (e.g., 2-[4-[(4-aminophenyl)diazenyl]-N-(2-hydroxyethyl) anilino]ethanol). Examples of anthraquinone dye molecules include one or more of Vat Black 25 (e.g., CAS No. 4395-53-3) and Acid Black 48 (e.g., 1-(4-amino-9,10-dihydroxyanthracen-1-yl)imino-4-iminoanthracene-9,10-dione). An example of suitable sulfur dye molecules includes sulfur black 1 (e.g., 2,10-dinitro-12H-[1,4]benzothiazino [3,2-b]phenothiazin-3-one). Examples of inorganic dye molecules include copper chromite black, carbon black, iron oxide black, manganese oxide black, and chromium oxide black. As mentioned, the second particles or molecules 44 can have a positive charge.

The vacuum insulated apparatus 2 can take a variety of forms. As will be discussed in greater detail below, the vacuum insulated apparatus 2 can be a refrigeration appliance. However, the vacuum insulated apparatus 2 is not so limited. Other applications for the vacuum insulated apparatus include other consumer appliances such as dishwashers, ovens, dryers, and microwaves, among other things. Still other applications for the vacuum insulated apparatus include dewars. The chamber 8 of such dewars, such as cryogenic dewars, can hold liquid nitrogen or some other substance at a range of temperatures below ambient temperature.

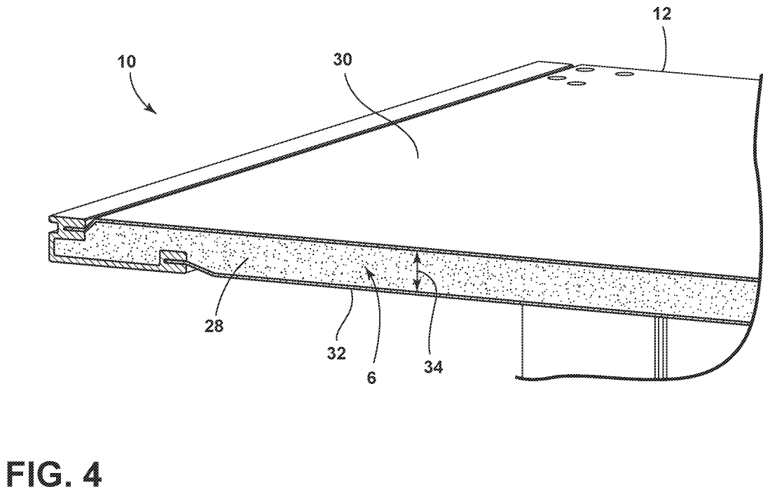

Referring to FIGS. 2-5, as mentioned, the vacuum insulated apparatus 2 can be a refrigeration appliance 10. The refrigeration appliance 10 includes a cabinet 12, as the insulative structure 4. The cabinet 12 defines at least one refrigeration compartment 14 that is separated from an external environment 16. The refrigeration appliance 10 further includes one or more doors 18 and/or drawers 20 in cooperation with the cabinet 12. The doors 18 and/or drawers 20 can be manipulated to, from, and between a closed position 22, which denies access to the refrigeration compartment 14 from the external environment 16, and an open position (not illustrated), which allows access to the refrigeration compartment 14 from the external environment 16. The one or more doors 18 may be attached to the cabinet 12 via hinges 24. The refrigeration appliance 10 further includes a refrigeration system 26 to maintain a temperature within the at least one refrigeration compartment 14 at or below a preset temperature. For example, the at least one refrigeration compartment 14 can be a fresh food compartment 14a where the preset temperature is within a range of about 1.4° C. to about 4.4° C. As another example, the at least one refrigeration compartment 14 can be a freezer compartment 14b where the preset temperature is within a range of about −18° C. to about −23° C. These preset temperature ranges are just examples and not meant to be exclusive.

The cabinet 12 includes the core insulation material 28. In embodiments, the cabinet 12 includes an outer wrapper 30 and an inner liner 32. The outer wrapper 30 at least partially envelopes the inner liner 32 and together form the sealed interior volume 6 with a space 34 separating the outer wrapper 30 from the inner liner 32. The core insulation material 28 is disposed within the sealed interior volume 6, that is, within the space 34.

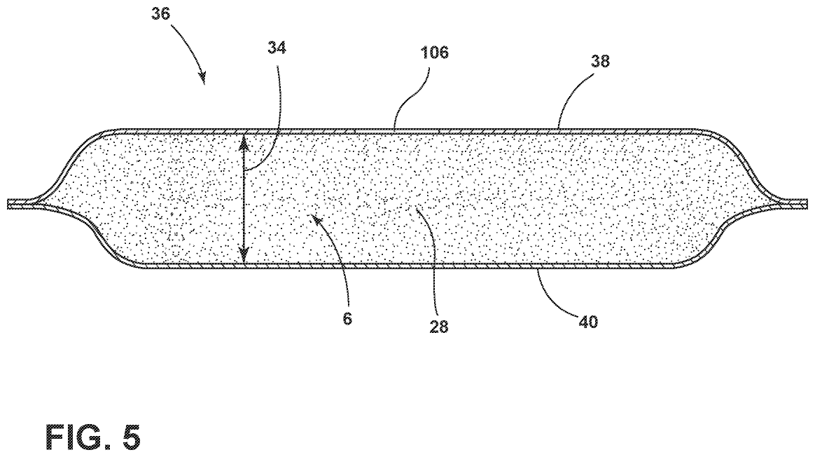

In other embodiments, the cabinet 12 includes one or more panels 36 (see FIG. 5) disposed around the refrigeration compartment 14. Each panel 36 includes a first liner 38 and a second liner 40 that together form the sealed interior volume 6. The second liner 40 faces, but is separated from, the first liner 38 by the space 34. The core insulation material 28 is disposed within the sealed interior volume 6, that is, within the space 34 between the first liner 38 and the second liner 40.

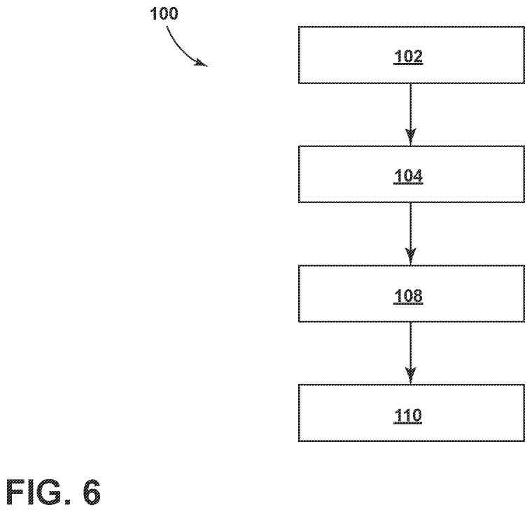

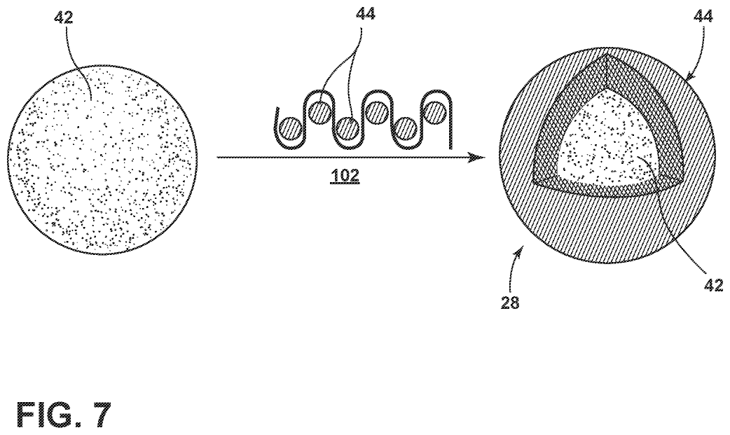

Referring now to FIGS. 6-7, a method 100 of manufacturing the vacuum insulated apparatus 2 is herein described. At a coating step 102 (see FIG. 7), the method 100 includes coating or bonding the first particles 42 with the second particles or molecules 44 to form the core insulation material 28. For example, the second particles or molecules 44 can be mixed with the first particles 42. In some instances, a high shear stress can be imparted during mixing to encourage the second particles or molecules 44 to coat and/or bond to the first particles 42. In some instances, the mixture of the first particles 42 and the second particles or molecules 44 can be heated to encourage bonding and/or coating. As another example, the second particles or molecules 44 can be placed in solution with a solvent and the first particles 42 are then added to the solution. The solvent can then be evaporated, leaving the second particles or molecules 44 coated upon or bonded to the first particles 42. As another example, the surfaces of the first particles 42 are first modified to facilitate bonding to the second particles or molecules 44.

After the coating step 102, the core insulation material 28 exhibits a black or gray color. The discussions above concerning the first particles 42, the second particles or molecules 44, and the CIELAB color coordinates that the core insulation material 28 exhibits apply equally as well here.

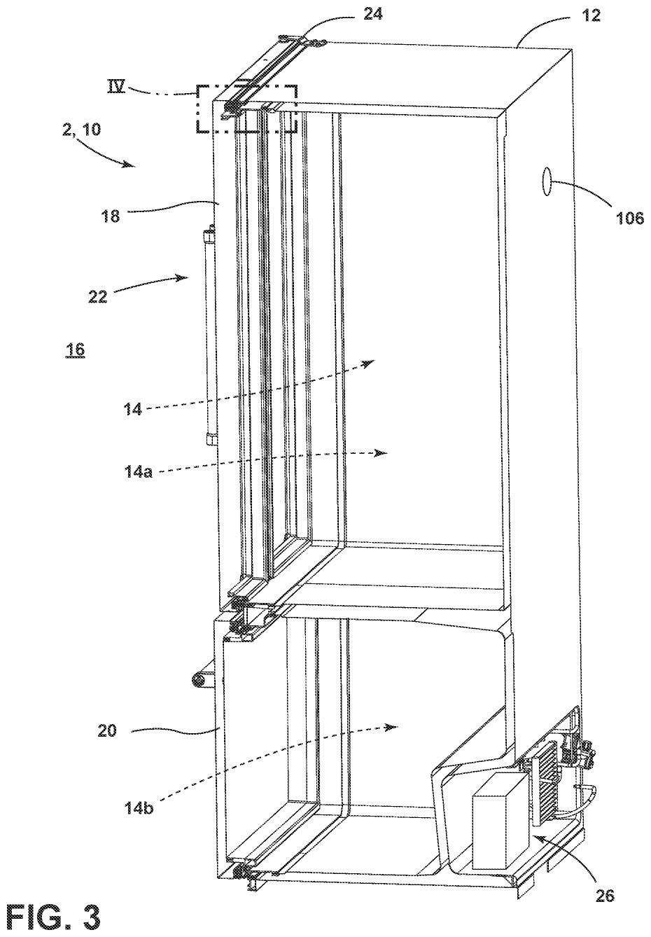

At a depositing step 104, the method 100 further includes depositing the core insulation material 28 into the interior volume 6 of the insulative structure 4. For example, when the insulative structure 4 pertains to the refrigeration appliance 10, the depositing step 104 can include depositing the core insulation material 28 into the panel 36 or the cabinet 12 for the refrigeration appliance 10. For example, the panel 36 and the cabinet 12 can include a port 106 (see FIGS. 3 and 5) through which the core insulation material 28 is inserted. Gravity can be utilized to pull the core insulation material 28 down into the cabinet 12. The core insulation material 28 is deposited into the space 34 of the panel 36 or the cabinet 12.

In embodiments, at a sealing step 108, the method 100 further includes reducing a pressure within the interior volume 6 of the insulative structure 4 and sealing the interior volume 6. For example, when the insulative structure 4 pertains to the refrigeration appliance 10, the sealing step 108 includes reducing the pressure within the space 34 of the panel 36 or the cabinet 12 within which the core insulation material 28 is disposed, and then sealing the panel 36 or the cabinet 12 to form the vacuum insulated panel 36 or the vacuum insulated cabinet 12, as the insulative structure 4. For example, a vacuum pump (not illustrated) can be placed in communication with the space 34 through the port 106. The vacuum pump reduces the pressure within the space 34. The port 106 can then be sealed. The core insulation material 28 thus exists in the space 34, which has a pressure that is below atmospheric pressure.

In embodiments, the method 100 further includes an assembly step 110. The assembly step 110 includes assembling the refrigeration appliance 10 with the insulative structure 4, e.g., with the panel 36 or the cabinet 12. For example, the panel 36 can be installed within the cabinet 12 and/or the doors 18. The doors 18 can be coupled to the cabinet 12 and the refrigeration system 26 installed.

The core insulation material 28 exhibits a total thermal conductivity that is less than a total thermal conductivity that the first particles 42 alone exhibit. Without being bound by theory, it is believed that the total thermal conductivity through the space 34 is the sum of the solid conductivity, the gaseous conductivity, and the radiative conductivity. The present disclosure addresses the aforementioned problem because the core insulation material 28 described herein has the benefits of both a low solid conductivity (due to the small size and porosity of the first particles 42) and a low radiative conductivity (due to the dark color of the second particles or molecules 44). The presence of the second particles or molecules 44 bonded to or coated upon the first particles 42 does not make the core insulation material 28 significantly larger than the first particles 42 alone. The gaseous conductivity is addressed by evacuating the space 34 of air and maintaining the space 34 at the reduced pressure lower than atmospheric pressure. The core insulation material 28 requires no opacifiers beyond the second particles or molecules 44 bonded to or coated upon the first particles 42.

According to a first aspect of the present disclosure, a vacuum insulated apparatus comprises: (a) an insulative structure forming a sealed interior volume having a pressure of less than atmospheric pressure; and (b) core insulation material disposed within the sealed interior volume, the core insulation material exhibiting a dark color and comprising (i) first particles and (ii) second particles or molecules coated onto or bonded to the first particles.

According to a second aspect of the present disclosure, the vacuum insulated apparatus of the first aspect is presented wherein, the core insulation material exhibits CIELAB color space coordinates that have an L* value within a range of from 0 to 40.

According to a third aspect of the present disclosure, the vacuum insulated apparatus of any one of the first through second aspects is presented, wherein the second particles or molecules are coated onto or bonded to the first particles or molecules via Van der Walls forces, hydrogen bonding, ionic bonding, or covalent bonding.

According to a fourth aspect of the present disclosure, the vacuum insulated apparatus of any one of the first through third aspects is presented, wherein the first particles are chosen from a group consisting of fumed silica, perlite, vermiculite, expanded polystyrene, polyurethane, and glass fiber.

According to a fifth aspect of the present disclosure, the vacuum insulated apparatus of any one of the first through fourth aspects is presented, wherein the first particles, without the second particles or molecules coated onto or bonded thereto, exhibit CIELAB color space coordinates that have an L* value that is greater than 40.

According to a sixth aspect of the present disclosure, the vacuum insulated apparatus of any one of the first through fifth aspects is presented, wherein the second particles or molecules are chosen from a group consisting of organic dye molecules and inorganic dye particles or molecules.

According to a seventh aspect of the present disclosure, the vacuum insulated apparatus of the sixth aspect is presented, wherein the organic dye molecules are chosen from a group consisting of azo dye molecules, anthraquinone dye molecules, phthalocyanine molecules, quinoline dye molecules, and sulfur dye molecules.

According to an eighth aspect of the present disclosure, the vacuum insulated apparatus of the seventh aspect is presented, wherein the azo dye molecules are chosen from a group consisting of Direct Black 38, Acid Black 210, Naphthol Blue Black, Reactive Black 5, and Disperse Black 9.

According to a ninth aspect of the present disclosure, the vacuum insulated apparatus of the seventh aspect is presented, wherein the anthraquinone dye molecules are chosen from a group consisting of Vat Black 25 and Acid Black 48.

According to a tenth aspect of the present disclosure, the vacuum insulated apparatus of the seventh aspect is presented, wherein the sulfur dye molecules comprise molecules of sulfur black 1.

According to an eleventh aspect of the present disclosure, the vacuum insulated apparatus of the sixth aspect is presented, wherein the inorganic dye molecules are chosen from a group consisting of copper chromite black, carbon black, iron oxide black, manganese oxide black, and chromium oxide black.

According to a twelfth aspect of the present disclosure, the vacuum insulated apparatus of any one of first through eleventh aspects is presented, wherein the core insulation material exhibits a total thermal conductivity that is less than a total thermal conductivity that the first particles alone exhibit.

According to a thirteenth aspect of the present disclosure, a method of manufacturing a vacuum insulated apparatus comprises: (a) a coating step comprising coating or bonding first particles with second particles or molecules to form core insulation material; (b) a depositing step comprising depositing the core insulation material into an interior volume of an insulative structure; and (c) a sealing step comprising reducing a pressure within the interior volume of the insulative structure within which the core insulation material is disposed and sealing the interior volume.

According to a fourteenth aspect of the present disclosure, the method of the thirteenth aspect is presented, wherein the core insulation material exhibits (i) a black or gray color and (ii) CIELAB color space coordinates having an L* value within a range of from 0 to 40.

According to a fifteenth aspect of the present disclosure, the method of any one of the thirteenth through fourteenth aspects is presented, wherein (i) the first particles have a negative surface charge, and (ii) the second particles have a positive charge.

According to a sixteenth aspect of the present disclosure, the method of any one of the thirteenth through fifteenth aspects is presented, wherein the first particles are chosen from a group consisting of fumed silica, perlite, vermiculite, expanded polystyrene, polyurethane, and glass fiber.

According to a seventeenth aspect of the present disclosure, the method of any one of the thirteenth through sixteenth aspects is presented, wherein the second particles or molecules comprise one or more of organic dye molecules and inorganic dye particles or molecules.

According to an eighteenth aspect of the present disclosure, the method of any one of the thirteenth through seventeenth aspects further comprises: an assembly step comprising assembling a refrigeration appliance with the insulative structure.

According to a nineteenth aspect of the present disclosure, a refrigeration appliance comprises: (a) an insulative structure with a sealed interior volume having a pressure of less than atmospheric pressure; and (b) core insulation material disposed within the sealed interior volume, the core insulation material exhibiting a dark color and comprising first particles and second particles or molecules coated onto or bonded to the first particles, wherein (i) the core insulation material exhibits CIELAB color space coordinates that have an L* value within a range of from 0 to 40, (ii) the second particles or molecules are coated onto or bonded to the first particles or molecules via Van der Walls forces, hydrogen bonding, ionic bonding, or covalent bonding, (iii) the first particles are chosen from a group consisting of fumed silica, perlite, vermiculite, expanded polystyrene, polyurethane, and glass fiber, (iv) the first particles, without the second particles or molecules coated onto or bonded thereto, exhibit CIELAB color space coordinates that have an L* value that is greater than 40, and (v) the core insulation material exhibits a total thermal conductivity that is less than a total thermal conductivity that the first particles alone exhibit.

According to a twentieth aspect of the present disclosure, the refrigeration appliance of the nineteenth aspect further comprises: (a) at least one refrigeration compartment; and (b) a refrigeration system configured to maintain a temperature within the at least one refrigeration compartment at or below a preset temperature.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A vacuum insulated apparatus comprising:
an insulative structure forming a sealed interior volume having a pressure of less than atmospheric pressure; and
core insulation material disposed within the sealed interior volume, the core insulation material exhibiting a dark color and comprising (i) first particles and (ii) second particles or molecules coated onto or bonded to the first particles.

2. The vacuum insulated apparatus of claim 1, wherein
the core insulation material exhibits CIELAB color space coordinates having an L* value within a range of from 0 to 40.

3. The vacuum insulated apparatus of claim 1, wherein
the second particles or molecules are coated onto or bonded to the first particles or molecules via Van der Walls forces, hydrogen bonding, ionic bonding, or covalent bonding.

4. The vacuum insulated apparatus of claim 1, wherein
the first particles are chosen from a group consisting of fumed silica, perlite, vermiculite, expanded polystyrene, polyurethane, and glass fiber.

5. The vacuum insulated apparatus of claim 1, wherein
the first particles, without the second particles or molecules coated onto or bonded thereto, exhibit CIELAB color space coordinates having an L* value that is greater than 40.

6. The vacuum insulated apparatus of claim 1, wherein
the second particles or molecules are chosen from a group consisting of organic dye molecules and inorganic dye particles or molecules.

7. The vacuum insulated apparatus of claim 6, wherein
the organic dye molecules are chosen from a group consisting of azo dye molecules, anthraquinone dye molecules, phthalocyanine molecules, quinoline dye molecules, and sulfur dye molecules.

8. The vacuum insulated apparatus of claim 7, wherein
the azo dye molecules are chosen from a group consisting of Direct Black 38, Acid Black 210, Naphthol Blue Black, Reactive Black 5, and Disperse Black 9.

9. The vacuum insulated apparatus of claim 7, wherein
the anthraquinone dye molecules are chosen from a group consisting of Vat Black 25 and Acid Black 48.

10. The vacuum insulated apparatus of claim 7, wherein
the sulfur dye molecules comprise molecules of sulfur black 1.

11. The vacuum insulated apparatus of claim 6, wherein
the inorganic dye molecules are chosen from a group consisting of copper chromite black, carbon black, iron oxide black, manganese oxide black, and chromium oxide black.

12. The vacuum insulated apparatus of claim 1, wherein
the core insulation material exhibits a total thermal conductivity that is less than a total thermal conductivity that the first particles alone exhibit.

13. A method of manufacturing a vacuum insulated apparatus comprising:
a coating step comprising coating or bonding first particles with second particles or molecules to form core insulation material;
a depositing step comprising depositing the core insulation material into an interior volume of an insulative structure; and
a sealing step comprising reducing a pressure within the interior volume of the insulative structure within which the core insulation material is disposed and sealing the interior volume.

14. The method of claim 13, wherein
the core insulation material exhibits (i) a black or gray color and (ii) CIELAB color space coordinates having an L* value within a range of from 0 to 40.

15. The method of claim 13, wherein
the first particles have a negative surface charge, and
the second particles have a positive charge.

16. The method of claim 13, wherein
the first particles are chosen from a group consisting of fumed silica, perlite, vermiculite, expanded polystyrene, polyurethane, and glass fiber.

17. The method of claim 13, wherein
the second particles or molecules comprise one or more of organic dye molecules and inorganic dye particles or molecules.

18. The method of claim 13 further comprising:
an assembly step comprising assembling a refrigeration appliance with the insulative structure.

19. A refrigeration appliance comprising:
an insulative structure with a sealed interior volume having a pressure of less than atmospheric pressure; and
core insulation material disposed within the sealed interior volume, the core insulation material exhibiting a dark color and comprising (i) first particles and (ii) second particles or molecules coated onto or bonded to the first particles,
wherein, the core insulation material exhibits CIELAB color space coordinates that have an L* value within a range of from 0 to 40,
wherein, the second particles or molecules are coated onto or bonded to the first particles or molecules via Van der Walls forces, hydrogen bonding, ionic bonding, or covalent bonding,
wherein, the first particles are chosen from a group consisting of fumed silica, perlite, vermiculite, expanded polystyrene, polyurethane, and glass fiber,
wherein, the first particles, without the second particles or molecules coated onto or bonded thereto, exhibit CIELAB color space coordinates that have an L* value that is greater than 40, and
wherein, the core insulation material exhibits a total thermal conductivity that is less than a total thermal conductivity that the first particles alone exhibit.

20. The refrigeration appliance of claim 19 further comprising:
at least one refrigeration compartment; and
a refrigeration system configured to maintain a temperature within the at least one refrigeration compartment at or below a preset temperature.
